(19) United States
(12) Patent Application Publication
(10) Pub. No.: US 2015/0324865 A1
(43) Pub. Date: Nov. 12, 2015

(54) ADVERTISING CAMPAIGN MANAGEMENT

(71) Applicants: Rebecca Illowsky, Menlo Park, CA (US); Joshua Sykes, San Francisco, CA (US)

(72) Inventors: Rebecca Illowsky, Menlo Park, CA (US); Joshua Sykes, San Francisco, CA (US)

(73) Assignee: GOOGLE INC., Mountain View, CA (US)

(21) Appl. No.: 13/353,663

(22) Filed: Jan. 19, 2012

(51) Int. Cl. G06Q 30/02

(52) U.S. Cl. CPC G06Q 30/0276

(57) ABSTRACT

Methods, systems, and apparatus, including computer programs encoded on a computer storage medium, for development and management of campaigns based on advertising campaign goals.

### BACKGROUND

This specification relates to advertising over multiple media channels.

The Internet enables access to a wide variety of content items, e.g., video and/or audio files, web pages for particular subjects, news articles, etc. Such access to these content items enables opportunities for targeted advertising. For example, advertisements can be provided with search results in response to a search query provided by a user; provided for web pages of online publishers that have content related to the advertisement; or provided in response to a specific request from a user, such as when a user requests information for particular products or services.

Additionally, with the advent of multi-media channel coordination, advertising can be coordinated over different media channel types. As used in this specification, a media channel type is a specific medium, or specific sub-portion of a specific medium, that is used in reaching an intended audience. For example, television, radio and the Internet are each different media channel types. Additionally, advertisements are delivered over the Internet through different sub-portions, e.g., such as mobile search, desktop search, desktop browsing, each of which are likewise different media channel types.

When designing an advertising campaign, the designer usually has a specific goal that the advertising campaign is intended to achieve. For example, a particular advertising campaign may be designed to increase brand recognition; another advertising campaign may be designed to sell products and services; another advertising campaign may be designed to reengage with customers. Each of these advertising campaigns, accordingly, will have different types of advertisements to achieve the different types of goals for which they are designed. Other types of goals are possible, such as driving offline (in-store) sales, increasing ROI (Return On Investment), increasing traffic, increasing the number of conversions, and increasing emotional engagement with a brand, etc.

However, with many different media channel types to choose from, designing an advertising campaign for a particular goal can be difficult. For example, to increase brand recognition, an advertiser may need to decide which media channel type(s) to use to deliver advertisements. For example, the advertiser may need to decide, when configuring a campaign, whether to choose a subset of media channel types or choose all media channel types. For example, the advertiser may include a single media channel type in a campaign or may “bundle”, for example, a desktop search media type and a mobile search media type, into a search-related campaign. As another example, the advertiser may include all available media channel types in a single campaign. Furthermore, when particular media channel types are selected, the advertiser may have multiple different types of advertising formats that can be used for advertisements. Thus, making an informed decision as to the selection media channel types, the format of advertisements, and the selection of other parameters can be a daunting task.

### SUMMARY

In general, one innovative aspect of the subject matter described in this specification can be embodied in methods that include displaying in the display device of the data processing apparatus a goal interface that comprises at least two goal selection input options, each of the goal selection input options corresponding to a respective advertising campaign goal for an advertising campaign of an advertising entity and being selectable by a user of the data processing apparatus, receiving a selection of one of the goal selection input options, and displaying, in the display device, a channel recommendation interface that includes a set of channel recommendations that are selected, in part, based on the respective advertising campaign goal corresponding to the selected one of the goal selection input options, the set including at least one recommendation for one or more advertising channels. In some variations, wherein the recommendation is for at least two advertising channels, each advertising channel being a particular media channel type for use in providing advertisements for the advertising campaign, and each media channel type that is recommended is different from the media channel type of at least one other advertising channel recommended in the set. Other embodiments of this aspect include corresponding systems, apparatus, and computer programs, configured to perform the methods, encoded on computer storage devices.

Another innovative aspect of the subject matter described in this specification can be embodied in methods that include receiving, from a client device, a selection of one of a plurality of goal selection input options, each of the goal selection input options corresponding to a respective advertising campaign goal for an advertising campaign of an advertising entity and being selectable by a user of the client device, the selection defining a selected goal; determining, based in part on the selected goal, a set of channel recommendations comprising at least one recommendation for advertising channels, each advertising channel comprising a particular media channel type for use in providing advertisements for the advertising campaign, and each media channel type being different from at least one other media channel type of the recommended advertising channels in the set; and providing, in response to the selected goal, data for displaying the set of channel recommendations at the client device. Other embodiments of this aspect include corresponding systems, apparatus, and computer programs, configured to perform the methods, encoded on computer storage devices.

Particular embodiments of the subject matter described in this specification can be implemented to realize one or more of the following advantages. One or more advertising campaigns can be automatically developed for an advertiser based on one or more advertising campaign goals selected by the advertiser. One or more advertising channels and default campaign data can be recommended to an advertiser based on one or more advertising campaign goals selected by the advertiser. An advertiser can view information for running advertising campaigns grouped according to previously selected advertising campaign goals. One or more advertisement formats can be recommended to an advertiser based on one or more advertising campaign goals selected by the advertiser. Relevant insights into best practices for and utility of media channels can be shown to an advertiser based on one or more advertising campaign goals selected by the advertiser. Relevant information relating to media channels (e.g., number of users available to be reached, frequency of reaching users, number of available impressions, number of web pages, number of search queries) can be shown to an advertiser based on one or more advertising campaign goals selected by the advertiser.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising environment.

FIG. 2 illustrates an example user interface for developing an advertising campaign.

FIG. 3 illustrates an example goal interface for defining one or more advertising campaign goals.

FIGS. 4 and 5 illustrate example channel recommendation interfaces for displaying a set of channel recommendations for one or more advertising channels.

FIG. 6 illustrates an example campaign development interface for defining an advertising campaign.

FIG. 7 illustrates an example advertisement development interface for displaying a set of advertisement format recommendations.

FIG. 8 illustrates an example user interface for displaying an overview of recommended advertising campaigns.

FIGS. 9 and 10 illustrate example campaign summary interfaces for managing advertising campaigns.

FIG. 11 is a flow diagram of an example process for developing an advertising campaign.

FIG. 12 is a flow diagram of an example process for displaying advertising campaign information.

FIG. 13 is a block diagram of a data processing apparatus system.

Like reference numbers and designations in the various drawings indicate like elements.

### DETAILED DESCRIPTION

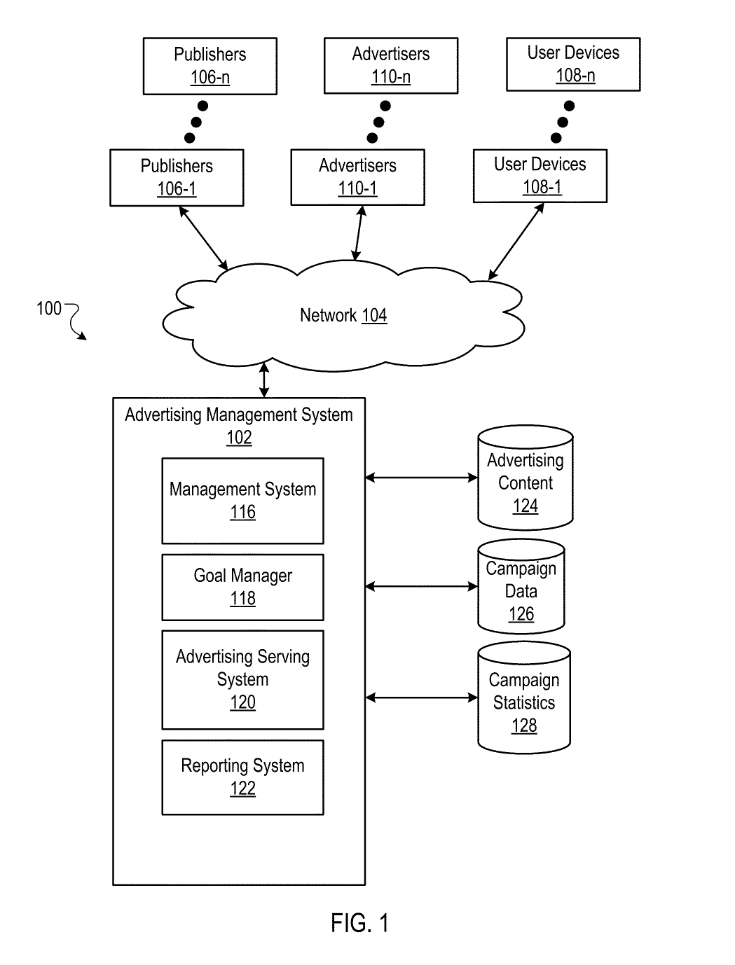

FIG. 1 is a block diagram of an example online advertising environment 100. The online advertising environment 100 utilizes an advertising management system 102 to facilitate the sale and purchase of online advertising opportunities between publishers and advertisers.

The online advertising environment 100 includes a computer network 104, such as a local area network (LAN), wide area network (WAN), the Internet, or a combination thereof, connecting publishers 106, user client devices 108, advertisers 110, and the advertising management system 102. The advertising management system 102 further has access to an advertising content store 124, a campaign data store 126, and a campaign statistics store 128.

Each publisher 106 is associated with one or more publisher websites (e.g., each respective publisher 106 can be an entity that manages and/or owns one or more websites). Each publisher website can have one or more webpage resources associated with a domain name, and can be hosted by one or more servers. An example website is a collection of webpages formatted in hypertext markup language (HTML) that can contain text, images, multimedia content, and programming elements.

User client devices 108 are electronic devices that are under the control of users. A user client device 108 typically includes a user application, such as a web browser, to facilitate the sending and receiving of data over the network 104.

The advertising management system 102 facilitates the sale and purchase of advertising opportunities between publishers 106 and advertisers 110. The advertising management system 102 includes components, such as a management system 116, a goal manager system 118, an advertising serving system 120, and a reporting system 122. An advertiser can create an advertising campaign using tools provided by the management system 116, or can create an advertising campaign using tools provided by the goal manager 118.

The management system 116 provides user interfaces for advertisers to define advertising campaigns and ad groups, submit advertising content, and specify various targeting and/or ad placement criteria for the advertising content in each advertising campaign and/or ad group. The advertising content is stored in the advertising content store 124 and the targeting and ad placement criteria are stored in the campaign data store 126. For each ad group or campaign, the advertisers can also specify bids for ad slots associated with particular keywords through the interface provided by the management system 116. Advertisers' bids, budgets, as well as other campaign related preferences are also stored in the campaign data store 126.

An account management tool can be employed by an advertiser to create and manage a large number of online advertising campaigns for various products and services that the advertiser offers. The account management tool can be made available to the advertiser either through an online interface provided by the management system 116 or as an account management software application installed and executed locally at an advertiser's client device. The online interface and/or the locally executed account management software application can be used for downloading existing account data from the management system 116 and for uploading new and/or modified account data to the management system 116.

The advertiser can create and manage multiple advertising campaigns using the account management tool offered by the management system 116. The advertiser can further specify multiple ad groups under each ad campaign, and specify respective advertisements, budgets, keywords, and other targeting and/or ad placement criteria for each of the ad groups. Typically, the advertising account can be abstracted into a hierarchical structure. For example, the advertising account can include one or more ad campaigns, each ad campaign can include one or more ad groups, and each ad group can include one or more advertisements and keywords.

An advertising campaign is defined by campaign level advertising parameters. The campaign level advertising parameters include, for example, a campaign name, a preferred content network for placing ads, a budget for the ad campaign, start and end dates for the ad campaign, a schedule for ad placements, a targeted language, and targeted geographical locations. Other campaign level advertising parameters includes, for example, a payment scheme such as a cost-per-click (CPC), cost per thousand impressions (CPM), cost-per-action (CPA), and so on.

The ad campaign includes one or more ad groups. An ad group contains one or more advertisements, which target a particular set of keywords, ad placements, or both. Ad groups under the same campaign can share the same campaign level advertising parameters, but have tailored specifications for particular ad group level advertising parameters, such as keywords, bids for keywords, budget, and so on.

Different ad groups are created to have more focused targeting on different product lines or services. For example, different sets of keywords specific to the different product lines or services can be used for the different ad groups. Sometimes, different ad groups can also target different market segments and/or demographic characteristics. Keywords specific for the different market segments and/or demographic characteristics can be included in the different ad groups.

An ad group is defined by ad group level advertising parameters. The ad group level advertising parameters include, for example, an ad group name, and various bids for different ad placement opportunities (e.g., automatic placement, advertiser managed placement, etc.) or outcomes (e.g., clicks, impressions, conversions). An ad group name can be one or more terms that the advertiser can use to concisely capture a topic or subject matter that the ad group is targeting. For example, a car dealership can create a different ad group for each type of vehicles it carries, and may further create a different ad group for each model of vehicles it carries. Examples of the ad group themes that the car dealership can use include, for example, “sports car,” “sedan,” “truck,” “hybrid,” and so on.

One or more keywords and advertisements are specified for each ad group. The keywords are typically terms that are relevant to the product or services that the advertiser wishes to promote for the ad group. Each keyword can include one or more terms. For example, the car dealership may include “automobile”, “sports car,” “V-6 engine,” “four-wheel drive,” “fuel efficiency,” and so on as keywords for its ad groups and ad campaigns. The advertiser can also specify whether exact match of keywords are required for ad placements on the content network.

In addition to keywords, for each ad group, a number of advertisements for selection by the ad server when an advertising opportunity becomes available that matches the budget, ad schedule, maximum bids, keywords, and other targeting criteria are specified. Different types of ads can be included in an ad group, such as a text ad, an image ad, a local business ad, a mobile ad, and so on.

Other aspects of the ad group can be defined in terms of various advertising parameters and specified by advertiser-entered values or default values for those various advertising parameters. After all the required advertising parameters for each level and aspect of the ad campaign(s) are specified, the advertising campaign data (e.g., data including the campaign structure and the advertising parameters on each level within the campaign structure) are uploaded to the management system 116, and the data are stored in the campaign data store 126. The advertising campaign can be created and activated according to the advertising campaign data specified by the advertiser.

In some implementations, an advertiser can create an advertising campaign using the goal manager 118. The goal manager 118 can provide a set of user interfaces for developing an advertising campaign. The user interfaces can include, for example, a goal interface, a channel recommendation interface, a campaign development interface, and an advertisement development interface.

The goal interface can include two or more goal selection input options which allow an advertiser 110 to select one or more advertising campaign goals for an advertising campaign. Advertising campaign goals can include, for example, brand recognition, sales, and customer re-engagement. Rather than the advertiser manually creating various advertising campaigns and associated campaign parameters, the goal manager 118 can recommend advertising channels, advertising campaigns, and associated campaign parameters, based on the advertiser's selected goal(s). For example, the channel recommendation interface includes a set of channel recommendations for advertising channels that are selected, by the goal manager 118, in part, based on the selected goal(s). Each advertising channel can be of a particular media channel type for use in providing advertisements for the advertising campaign.

The campaign development interface includes default campaign data selected by the goal manager 118 which defines one or more advertising campaigns for the advertiser 110. The default campaign data can be selected, in part, based on the set of channel recommendations. The default campaign data can include default campaign values for a plurality of campaign parameters that define a default advertising campaign strategy for the advertiser 110. Campaign parameters can include, for example, one or more budgets, one or more ad groups, one or more targeting keywords, and one or more bids. The advertisement development interface includes a set of advertisement format recommendations that are selected, by the goal manager 118, in part, based on a recommended advertising channel and a selected goal. The set of advertising format recommendations can include one or more recommended advertising formats for an advertisement to be provided over a particular recommended advertising channel. The advertiser 110 can review the recommended advertising campaigns and associated parameters and advertisements, and can start the recommended campaigns.

Referring now to the publishers 106, for some of the publishers 106, a respective publisher 106 can correspond to a particular media channel type. For example, in FIG. 1, there are n media channel types shows, and each channel type has a corresponding set of publishers 106, advertisers 110, and user devices 108 that send and receive data of the particular media channel type. For example, the publishers 106-1 can publish content on a video media channel, the publishers 106-2 can publish content on one or more mobile channels, and the publishers 106-n can publish content on one or more desktop channels. The publishers 106-1 . . . 106-n can, for example, include a same particular publisher 106, if, for example, the particular publisher entity publishes content on different media channels. Likewise, the advertisers 110-1 . . . 110-n and user devices 108-1 . . . 108-n can include the same particular advertisers and user devices when the advertiser entity advertises on different media channels and the user device receives data for the articular media channel (e.g., a desktop search channel that shows ads with search results and a targeted content channel that shows ads that are contextually matched to a publisher web page).

The advertising management system 102 provides an interface for publishers 106 to specify ad slots available on the publisher's online properties. For example, the publishers 106 can specify the cost, type, dimensions, and targeting criteria (e.g., keywords associated with the content of the online properties) for each ad slot. A publisher management server (not shown) can provide scripts or references to scripts to the publishers 106 according to the specifications of the ad slots. Each publisher 106 can insert instructions into its webpages or content items (e.g., RSS feeds, social networks, videos, etc.). When the webpages and content items are downloaded to user client devices 108, the instructions are executed to generate one or more ad requests to the advertising management system 102. The advertising serving system 120 of the advertising management system 102 responds to the ad requests by sending advertisements to the requesting user client device 108 for insertion into appropriate ad slots in the publisher's webpages or content items as rendered on the requesting user client device 108. The advertisements can include embedded links to landing pages (e.g., webpages on the advertisers' websites 110) that a user is directed to when the user clicks on the advertisements presented on the publisher's webpages or in the content items.

The ad requests are optionally associated with user characteristics (e.g., user's age, gender, income, language preferences, and so on) and advertising context (e.g., keywords associated with webpage content, location, local time of ad request, and so on). In some implementations, the ad requests can be associated explicit user characteristics or inferred characteristics associated with a browser, cookie identifier, data indexed by a cookie identifier, etc.

In some implementations, various user privacy measures are implemented to remove personally identifiable information from the user characteristics data. The advertising serving system 120 can select advertisements from the advertising content store 124 for each ad request based on a match between an advertiser's campaign criteria in the campaign data store 126 and the user characteristics and advertising context associated with the ad request.

The advertisements provided after a successful match, and optionally user responses (e.g., click-throughs, conversions, and so on) to the advertisements, can be tracked by various tracking mechanisms (e.g., tracking cookies, pixel callbacks, etc.), sent back to the advertising management system 102, and stored in the campaign statistics store 128. The tracking is enabled by various user opt-in processes. The reporting system 122 provides user interfaces for advertisers and publishers to review reports on the campaign statistics in various formats. Performance of particular keywords, ad groups, and campaigns can be measured based on various performance metrics, such as cost per action (e.g., click or conversion), conversion length (e.g., number of clicks between initial impression and conversion), and so on.

The goal manager 118 can provide one or more interfaces that allow the advertiser 110 to manage and view reports for started campaigns. For example, the goal manager 118 can provide a campaign summary interface. The campaign summary interface includes two or more goal categories, each of which respectively correspond to one of the goal selection inputs included in the goal interface and a corresponding advertising campaign goal. For each of the goal categories, the campaign summary interface can include a listing of one or more advertising campaigns grouped according to the goal category, where each of the advertising campaigns in the listing is a campaign that is defined to achieve the respective advertising campaign goal that corresponds to the goal category. Each listing may be grouped, for example, according to a media channel type to which an advertising campaign corresponds. Each listing can include campaign parameter values and campaign statistics for each of the advertising campaigns that correspond to a respective media channel type. The campaign statistics can be accessed, for example, from the campaign statistics store 128.

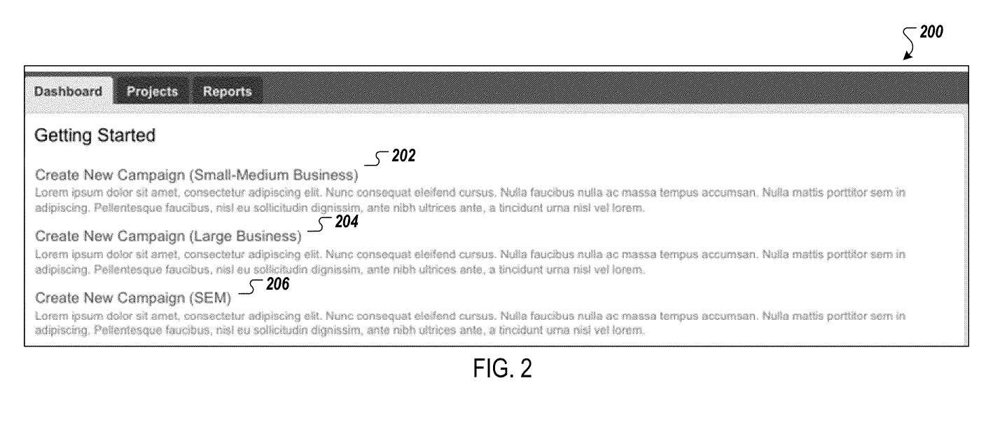

FIG. 2 illustrates an example user interface 200 for developing an advertising campaign. A user, such as an advertiser, can, for example, select a link 202, 204, or 206 to create a new advertising campaign for a small-to-medium business, for a large business, or for a SEM (search engine marketer, e.g., a business specializing in marketing using search engines), respectively. Although links are the illustrated user interface paradigm, other user interface elements can be used, e.g. buttons, drop down selections, etc.

As an example, a small-to-medium business, as compared to a large business, can have different needs, a different level of knowledge of marketing and advertising, and a different willingness and ability to invest in advertising and marketing. Accordingly, different workflows for advertising campaign creation can be provided for different types of businesses. Workflows for advertising campaign creation for other types of businesses other than small-to-medium businesses, large businesses, and search engine marketers can be provided.

Although in the example of FIG. 2, user-selectable links 202, 204, and 206 are displayed for a small-to-medium business, a large business, and a SEM respectively, in some implementations, other approaches may be used to determine a business type. For example, a business type can be determined automatically, such as from information previously provided by the advertiser that is retrieved from an advertiser profile. Other business type selection and determination approaches are possible. For example, a business type may be determined automatically if a user chooses a “default” workflow user interface. As another example, the user may be able to select a business type if the user chooses an “advanced” workflow user interface. In the example of FIG. 2, in response to selection of the link 202, 204, or 206, a user interface for developing one or more advertising campaigns for the selected business type can be displayed.

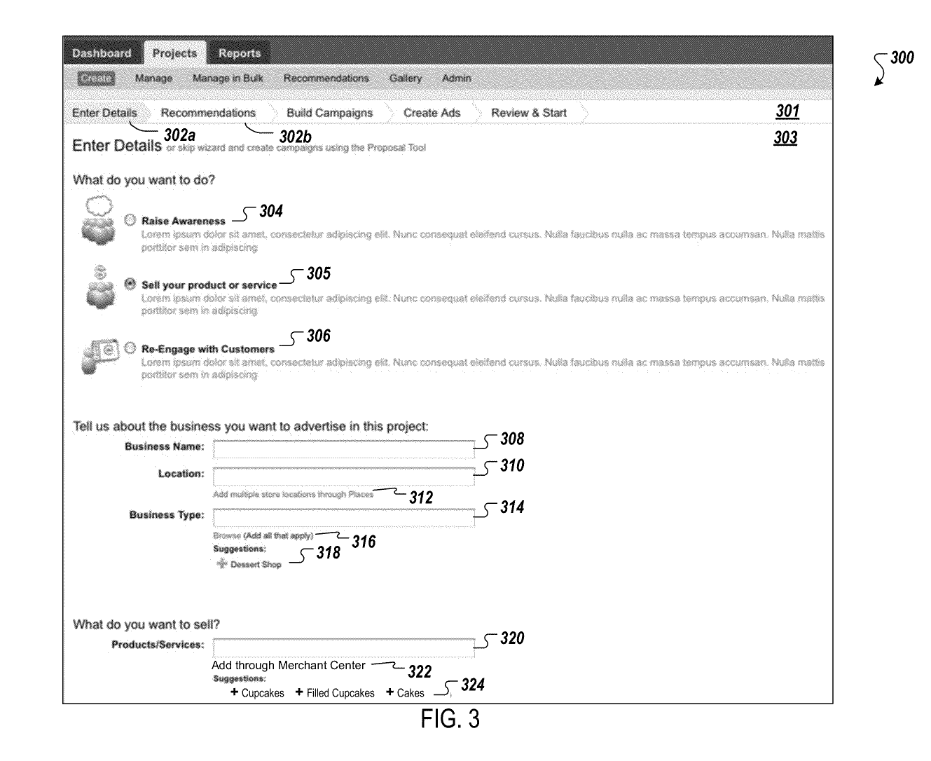

For example, FIG. 3 illustrates an example user interface 300. The user interface 300 includes a workflow user interface 301 for developing one or more advertising campaigns. The workflow user interface 301 includes tabs, such as tabs 302a and 302b, which correspond to workflow steps for developing one or more advertising campaigns. The tab 302a, which corresponds to a step for entering details for a business, can be an initial tab which is selected by default when the user interface 300 is displayed. In response to selection of the tab 302a, an example goal interface 303 for defining one or more advertising campaign goals can be displayed in the user interface 300. The goal interface 303 can be provided, for example, by the goal manager 118 described above with respect to FIG. 1.

The goal interface 303 includes goal selection input options 304, 305, and 306 (generally referred to as “goal selection inputs”). Each of the goal selection inputs 304, 305, and 306 correspond to a respective advertising campaign goal for one or more new advertising campaigns, where each respective advertising campaign goal achieves a different objective than the other advertising campaign goals. For example, the goal selection inputs 304, 305, and 306 correspond to goals of brand recognition (e.g., raising awareness of a brand), sales (e.g., selling a product or service), and re-engaging with customers, respectively. Re-engaging can include, for example, remarketing to a customer who has previously interacted with the business. For example, the business can re-market to a customer who abandoned a sale (e.g., the customer may have performed research without finalizing a purchase). As another example, the business can remarket to customers who previously made purchases, to build loyalty with those customers. Other goal selection inputs can correspond to other advertising campaign goals, where the other advertising campaign goals can be broader, more specific, or otherwise different from the advertising campaign goals corresponding to the goal selection inputs 304, 305, and 306. For example, the goal interface 303 can include goal selection inputs for a goal of driving traffic to a website or a goal of generating leads.

In some implementations, a user can select one or more of the goal selection inputs 304, 305, and 306. For example, the goal selection input 305 corresponding to a goal of sales is shown as selected. In some implementations, the user can select one but not more than one of the goal selection inputs 304, 305, and 306. The one or more selected goal selection inputs 304, 305, and 306 can define a set of one or more selected goals.

In addition to selecting one or more goals, a user can provide information about a business for which to advertise. For example, the user can provide a business name using a control 308 and can provide a business location using a control 310. If the business has multiple locations, the user can select a link 312 to provide information for the multiple locations.

As another example, the user can provide a business type, using a control 314. The user can select a link 316 to browse a predefined list of business types and can select one or more business types from the predefined list. One or more business type suggestions can be displayed in a suggested business types list 318. For example, one or more business types can be suggested based on a business name provided using the control 308. As another example, one or more business types can be suggested based on results of querying a business directory using a business name provided using the control 308 and/or a location provided using the control 310. The user can select one or more suggested business types in the suggested business types list 318. In some implementations, a business type is included in (e.g., automatically entered into) the control 314 in response to selection of a business type included in the suggested business types list 318. In some implementations, the suggested business types list 318 can be populated based on one or more provided product and service keywords.

For example, the user can provide one or more keywords that describe an offered product or service using a control 320. The user can select a link 322 to display a “merchant center” interface from which the user can select one or more products and services, such as by browsing a directory of predefined product and service categories. The user can select one or more suggested products or services from a suggested products and services list 324. The suggested products and services list 324 can be populated, for example, based on a business type provided using the control 314 and/or on a product or service keyword provided using the control 320. The keywords provided using the control 320 can correspond to a subset of products or services offered by the business. For example, the advertiser may want to create one or more advertising campaigns that focus on a subset of products or services, and may create one or more other advertising campaigns to focus on other offered products or services.

The goal manager 118 can recommend an advertising strategy based, in part, on the one or more selected goals and on the entered business name, business type, and product and service information. The user can view a user interface which presents the recommended advertising strategy by selecting the tab 302b.

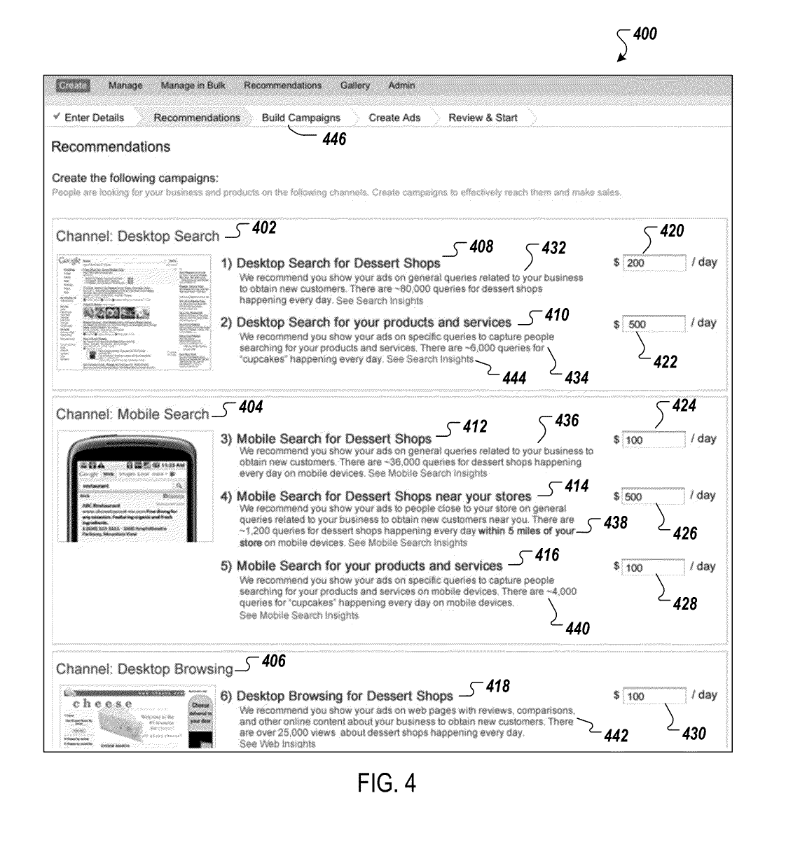

For example, FIG. 4 illustrates an example channel recommendation interface 400 for displaying a set of channel recommendations. The set of channel recommendations includes recommendations for recommended advertising channels 402, 404, and 406. Each of the recommended advertising channels 402, 404, and 406 is a particular media channel type for use in providing advertisements for one or more advertising campaigns, and each media channel type that is recommended is different from the other recommended media channel types. For example, the recommended advertising channel 402 is a desktop search media channel type, the recommended advertising channel 404 is a mobile search media channel type, and the recommended advertising channel 406 is a desktop browsing media channel type.

For each of the recommended advertising channels 402, 404, and 406, one or more advertising campaigns can be recommended, based, in part, on the user's selected advertising campaign goal(s). For example, for the desktop search advertising channel 402, an advertising campaign 408 for desktop searches for dessert shops and an advertising campaign 410 for desktop searches for products and services offered by the business (e.g., products or services corresponding to keywords provided using the control 320) are recommended. As another example, for the mobile search advertising channel 404, advertising campaigns 412, 414, and 416 for mobile searches for dessert shops, mobile searches for dessert shops by users who are proximate to the business, and mobile searches for products and services offered by the business, respectively, are recommended. As yet another example, for the desktop browsing advertising channel 406, an advertising campaign 418 for desktop browsing for dessert shops is recommended.

The goal manager 118 can recommend the recommended advertising channels 402, 404, and 406, and the corresponding recommended advertising campaigns 408-418, based, for example, on the selected advertising campaign goal(s), on the user-provided business information (e.g., business name, type), and on information stored by or accessible to the goal manager 118. The recommended advertising channels 402, 404, and 406 can be selected, from among other available advertising channels, based on the recommended advertising channels 402, 404, and 406 being more suitable for meeting the selected advertising campaign goal(s) than other available advertising channels. The recommended advertising channels 402, 404, and 406 and the corresponding recommended advertising campaigns 408-418 can be recommended based on historical user activity information, occurring on available advertising channels, that is related to the selected advertising campaign goal(s). For example, the historical user activity information, which may be accessed from the campaign statistics store 128 described above with respect to FIG. 1, may indicate that there are more searches for the business, the business type, or products and services offered by the business being performed on the recommended advertising channels 402, 404, and 406 than on other available advertising channels. Some or all of the recommended advertising channels 402, 404, and 406 and the corresponding recommended advertising campaigns 408-418 can be recommended based on best practices and industry knowledge included in the goal manager 118.

For each of the respective recommended advertising campaigns 408-418, a respective recommended budget 420-430 can be displayed. For example, as indicated by the budget 420, a daily budget of two hundred dollars is recommended for the recommended advertising campaign 408. The amount of each of the budgets 420-430 can be based, for example, on an advertiser-provided total budget and on estimates for each of the respective advertising campaigns 408-418 which each estimate an impact that a respective advertising campaign 408-418 may have towards meeting the selected advertising campaign goal(s). For example, the budget 426 of five hundred dollars daily for the recommended advertising campaign 414 may be higher than the two hundred dollar daily budget 420 for the recommended advertising campaign 408 based on the recommended advertising campaign 414 having a higher estimated impact towards achieving the selected advertising goal(s) than the recommended advertising campaign 408. As another example, the budgets 420-430 may be based, in part, on a general difference in cost for advertising for some or all of the corresponding recommended advertising campaign channels 402, 404, and 406.

For each of the respective recommended advertising campaigns 408-418, corresponding respective recommendation details 432-442 are displayed which provide, among other information, one or more reasons for why the respective recommended advertising campaign 408-418 is recommended to obtain the advertising campaign goal(s) selected by the user. For example, the recommendation details 432 describe that the recommended advertising campaign 408 can be used to satisfy a recommendation to show advertisements on general queries related to the business to obtain new customers for the business. The recommendation details 432 also describe that, historically, there have been approximately eighty thousand desktop search queries by customers, for dessert shops, per day. As another example, the recommendation details 438 describe that the recommended advertising campaign 414 can be used to satisfy a recommendation to show advertisements to customers close to the business on general queries related to the business to obtain new customers that are located near the business. The recommendation details 438 also describe that, historically, there have been approximately twelve hundred mobile search queries by customers, for dessert shops, per day, within five miles of the business.

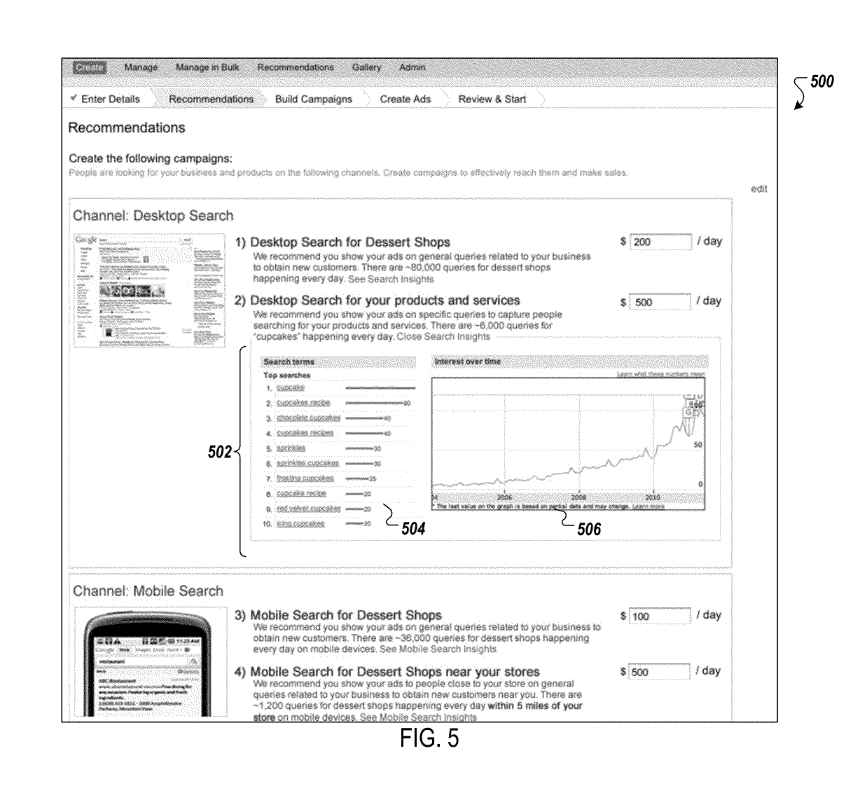

Some or all of the recommendation details 432-442 can include a link to more detailed information. For example, the recommendation details 434 includes a link 444 to search insights associated with the recommended advertising campaign 410. For example, a user interface 500 illustrated in FIG. 5 includes search insights 502 that are displayed in response to selection of the link 444. The search insights 502 include a list 504 of top search terms that include one or more keywords related to products and services offered by the business. The search insights 502 also include a graph 506 which illustrates historical counts of searches for the search terms included in the list 504.

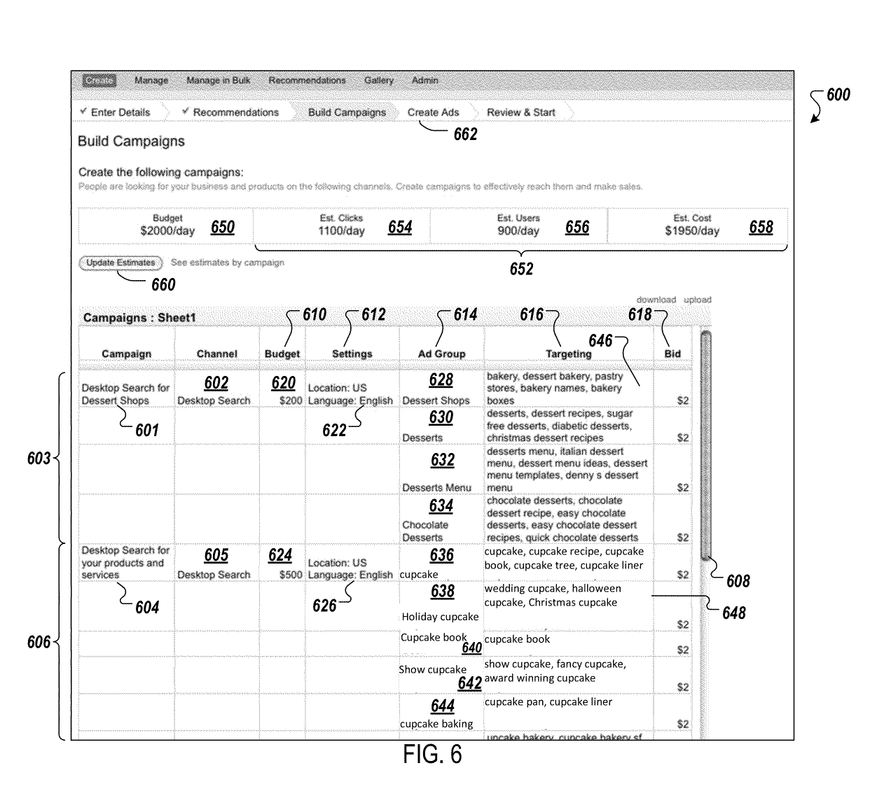

Returning to FIG. 4, the user can select a tab 446 to display a campaign development interface for building the recommended advertising campaigns 408-418 using the recommended advertising channels 402, 404, and 406. For example, FIG. 6 illustrates an example campaign development interface 600 which includes default campaign data defining one or more advertising campaigns for the advertiser. The campaign development interface 600 can include, for example, default campaign data which defines each of the recommended advertising campaigns 408-418. For example, default campaign data for an advertising campaign 601, of a desktop search media channel type 602, which corresponds to the recommended advertising campaign 408, is displayed in an area 603, and default campaign data for an advertising campaign 604, of a desktop search media channel type 605, which corresponds to the recommended advertising campaign 410, is displayed in an area 606. The user can use a scroll control 608 to scroll to view default campaign data associated with the recommended advertising campaigns 412-418.

The default campaign data displayed in the areas 603 and 606, for the advertising campaigns 601 and 604, respectively, include default campaign values for a plurality of campaign parameters. The default campaign values for the plurality of campaign parameters define a default advertising campaign strategy for the advertiser. The plurality of default campaign values are selected for the advertising campaigns 601 and 604, in part, based on the recommended advertising channels 402, 404, and 406, and are selected to meet the advertiser's previously selected goal(s).

The plurality of campaign parameters can include, for example, a budget 610, settings 612, one or more advertising groups 614, targeting keywords 616, and bids 618. For example, a default campaign value 620 defines a budget of two hundred dollars and a default campaign value 622 defines a location of the United States and a language of English, for the advertising campaign 601. Similarly, a default campaign value 624 defines a budget of five hundred dollars and a default campaign value 626 defines a location of the United States and a language of English, for the advertising campaign 604.

A strategy for each of the advertising campaigns 601 and 604 can include the creation of one or more advertising groups (e.g., corresponding to the parameter 614). For example, advertising groups 628-634, corresponding to dessert shops, desserts, desserts menu, and chocolate desserts, respectively, can be created for the advertising campaign 601. As another example, advertising groups 636-644, corresponding to cupcake, holiday cupcake, cupcake book, show cupcake, and cupcake baking, respectively, can be created for the advertising campaign 604.

For each of the advertising groups 628-644, a set of targeting keywords is defined (e.g., corresponding to the parameter 616). For example, targeting keywords 646 associated with the advertising group 628 for the advertising campaign 601 include bakery, dessert bakery, pastry stores, bakery names, and bakery boxes. As another example, targeting keywords 648 associated with the advertising group 638 for the advertising campaign 604 include wedding cupcake, Halloween cupcake, and Christmas cupcake. For each of the advertising groups 628-644, a bid amount can be defined (e.g., corresponding to the parameter 618). For example, as shown, a bid amount of two dollars is defined for each of the advertising groups 628-644.

A total daily budget 650 is displayed which, in some implementations, is the sum of the budgets for each of the recommended advertising campaigns. In some implementations, one or more advertising campaigns can share a budget. Estimates 652 are displayed which include cost and performance estimates based, for example, on the current total budget and on current default campaign values. For example, the estimates 652 include a daily click estimate 654, a daily users estimate 656, and a daily cost estimate 658. In some implementations, the user can edit the default campaign values 620-648 and can select a control 660 to update the total daily budget 650 and the estimates 652.

The particular parameters that are selected to define an advertising campaign can be selected based, in part, on a media channel type associated with a recommended advertising channel. For example, for some media channel types, such as desktop search, the advertising groups parameter 614 and the targeting keywords parameter 616 can be selected. For other media channel types, other parameters can be selected to define an advertising campaign, such as a list of recommended publisher websites on which advertisements are to be placed. As another example, one or more user lists to be targeted can be displayed, where targeting a displayed user list is identified as suitable for meeting the advertiser's selected goal(s).

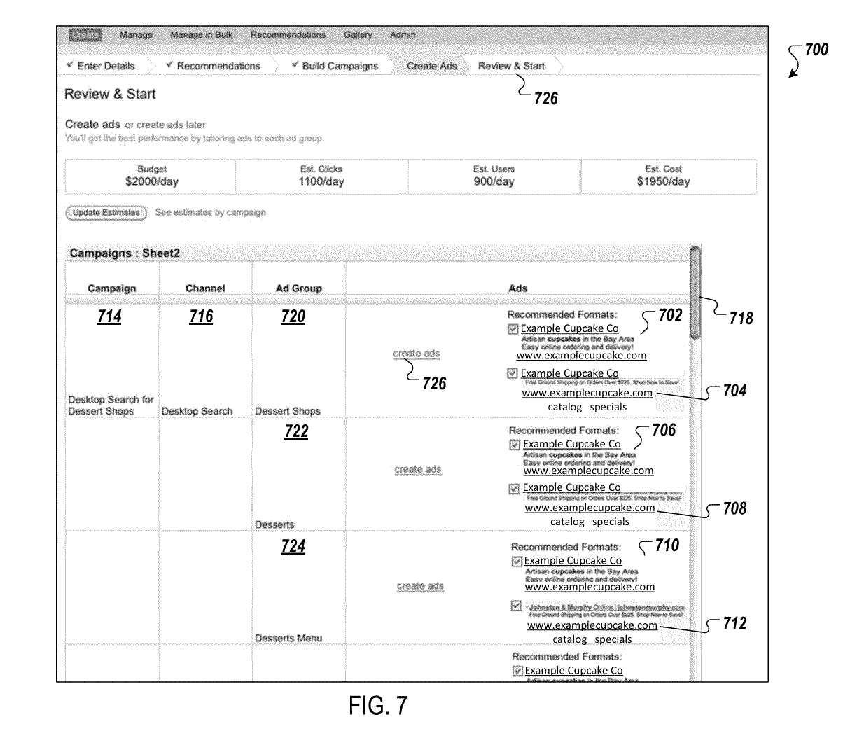

The user can select a tab 662 to display an advertisement development interface. For example, FIG. 7 illustrates an example advertisement development interface 700 for displaying a set of advertisement format recommendations, including recommended advertising formats 702-712. The recommended advertising formats 702-712 are selected for an advertising campaign 714 (which corresponds to the advertising campaigns 601 and 408), in part, based on an advertising channel 716 (which corresponds to the advertising channels 602 and 402) and on the advertiser's selected goal(s). The recommended advertising formats 702-712 can be used for an advertisement to be provided over the advertising channel 716. The user can use a scroll control 718 to scroll to view recommended advertisement formats for other recommended advertising campaigns for the advertising channel 716 and for other recommended advertising channels.

The recommended advertising formats 702-712 can be selected from among multiple advertising formats available for the advertising channel 716 and can be selected based on the recommended advertising formats 702-712 being more suited to achieving the advertiser's selected goal(s) than other advertising formats available on the advertising channel 716. Although text advertisement formats are shown, other advertisement formats can be recommended. For example, for a goal of awareness, a video advertisement format, an image advertisement format for display of advertisements on a publisher website, and a search result advertisement format, configured to compare two businesses, can be recommended, if, for example, the recommended advertising channels include video, display advertisements, and one or more search channels, respectively. As another example, for a goal of sales, a mobile advertisement format with click-to-call capability and a mobile location-aware advertisement format can be recommended, if, for example, mobile search and/or mobile browsing are recommended advertising channels.

Each of the recommended advertisement formats 702-712 can be selected based on a corresponding advertising group. For example, the advertising formats 702 and 704 correspond to an advertising group 720 (which corresponds to the advertising group 628), the advertising formats 706 and 708 correspond to an advertising group 722 (which corresponds to the advertising group 623), and the advertising formats 710 and 712 correspond to an advertising group 724 (which corresponds to the advertising group 632).

The user can select a link to create advertisements for a corresponding advertisement group, in one or more recommended advertising formats. For example, the user can select a link 726 to be presented with an interface for creating one or more advertisements in either the advertising format 702 or the advertising format 704. For some recommended advertising formats, such as video advertisement formats and advertising formats that include one or more images, the user can be provided with an interface to upload a video or image, respectively.

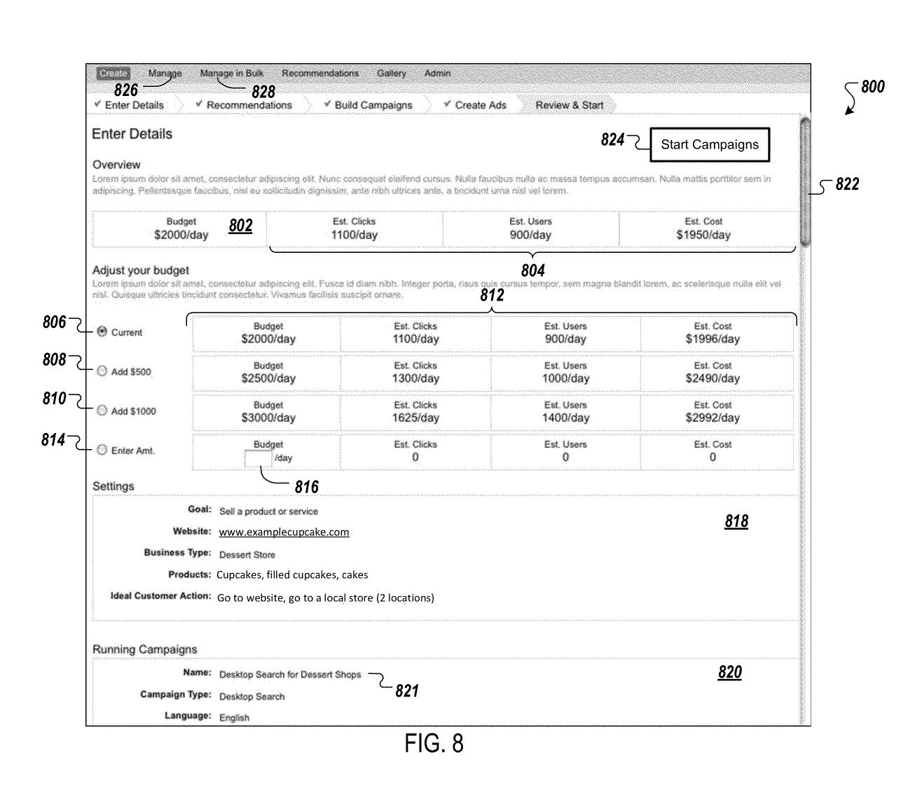

The user can select a tab 726 to display an interface for reviewing details of and for starting recommended advertising campaigns. For example, FIG. 8 illustrates an example user interface 800 for displaying an overview of recommended advertising campaigns. The user interface 800 includes a total daily budget 802 and corresponding cost and performance estimates 804 which correspond to the total daily budget 650 and the estimates 652, respectively. The user can select a control 806 to accept the total daily budget 802 and the corresponding cost and performance estimates 804 or can select a control 808 or a control 810 to increase the total daily budget 802 by five hundred or one thousand dollars, respectively. A table 812 documents the effects of selecting the control 806, 808, or 810 (e.g., in respective rows each corresponding to a respective control 806, 808, or 810). As another example, the user can select a control 814 and can enter a budget amount using a control 816. A corresponding row in the table 812 (e.g., the bottom row) can be updated to document the effects of setting the total daily budget 802 to the amount displayed in the control 816.

A summary of user inputs is displayed in a settings summary area 818. For example, the settings summary area 818 can include the user's selected goal(s), and user-provided business information, such as a business web site, a business name, a business type, and offered products or services. Summary information for recommended advertisement campaigns is displayed in a campaign area 820. For example, campaign values for a plurality of campaign parameters (e.g., as described above with respect to FIG. 6) can be displayed in the campaign area 820 for each recommended advertising campaign. For example, the campaign area 820 includes summary information for a recommended advertising campaign 821 (which corresponds to the recommended advertising campaigns 408, 601, and 714).

The user can use a scroll control 822 to scroll to see additional summary information for the recommended advertising campaign 821 or for other recommended advertising campaigns. The user can select a control 824 to finalize creation of and to start each of the recommended advertising campaigns. The user can select a control 826 or a control 828 to manage started advertising campaigns. The control 826 can be selected, for example, to display a basic campaign summary interface designed for unsophisticated users who are not very familiar with advertising. The control 828 can be selected, for example, to display a campaign summary interface designed for users who are familiar with advertising.

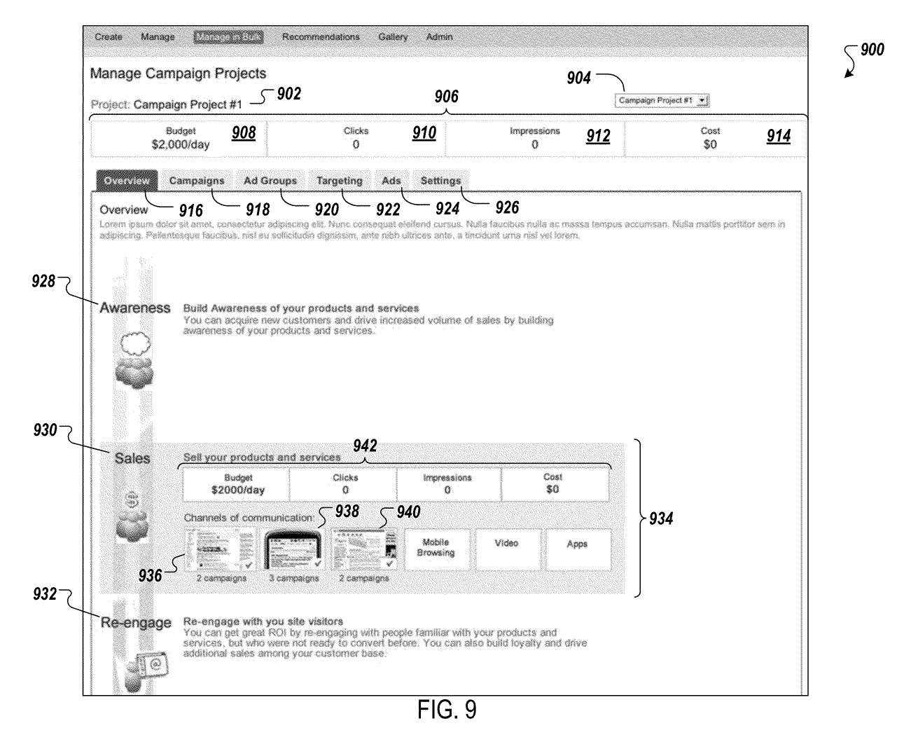

For example, FIG. 9 illustrates an example campaign summary interface 900 for managing advertising campaigns. The campaign summary interface 900 can display information for one or more campaign projects, where each campaign project can group related advertising campaigns. A campaign project can group advertising campaigns that meet one or more user-specified goals. As illustrated by a label 902, the campaign summary interface 900 is displaying information for a “campaign project #1”. The user can select a different campaign project using a control 904.

A statistics area 906 displays information associated with the campaign project. For example, a budget 908 can be displayed, which can be a sum of the budgets of the advertising campaigns included in the campaign project. Statistics 910, 912, and 914 display clicks information, impressions information, and cost information, respectively.

The user can select an overview tab 916, a campaigns tab 918, an ad groups tab 920, a targeting tab 922, an ads tab 924, or a settings tab 926 to see information associated with the advertising campaigns included in the campaign project. For example, in response to selection of the overview tab 916, advertising campaign information grouped by a set of goal categories 928, 930, and 932 can be displayed. Each goal category 928, 930, and 932 respectively corresponds to a previously displayed goal selection input (e.g., the goal selection inputs 304, 305, and 306, respectively, with respect to FIG. 3) and to the goal selection input's corresponding advertising campaign goal. For example, the goal categories 928, 930, and 932 correspond to goals of awareness, sales, and re-engagement, respectively.

For each of the goal categories 928, 930, and 932, a listing of one or more advertising campaigns grouped according to the goal category 928, 930, or 932 can be displayed. Each of the advertising campaigns in the listing is an advertising campaign that is defined to achieve the respective advertising campaign goal that corresponds to the goal category 928, 930, or 932. For example, a listing 934 groups advertising campaigns associated with the sales goal category 930. The listing 934 groups the advertising campaigns associated with the sales goal category 930 according to a media channel type to which a respective advertising campaign corresponds. For example, advertising campaign groups 936, 938, and 940 include two desktop search advertising campaigns, three mobile search advertising campaigns, and two desktop browsing advertising campaigns, respectively.

The listing 934 includes a statistics area 942 which can include similar types of information as the statistics area 906, with the statistics area 942 including information that is specific to advertising campaigns associated with the goal category 930. Although one listing 934 is displayed, a listing can also be displayed for either or both of the goal categories 928 and 932, if the selected campaign project includes advertising campaigns that are associated with the goals corresponding to the goal category 928 or the goal category 932. Information displayed in response to selection of the campaigns tab 918, the ad groups tab 920, the targeting tab 922, or the ads tab 924 can be grouped by goal category, similar to the information displayed in response to the overview tab 916. The user can select the settings tab 926 to edit settings for a campaign project, such as to edit or add one or more advertising campaign goals.

The user can select an advertising campaign group 936, 938, or 940 to view additional information for the advertising campaigns included in the selected advertising campaign group 936, 938, or 940. The advertising campaign groups 936, 938, and 940 can each be, in other words, a media type selection input, where each advertising campaign group 936, 938, and 940 corresponds to a media channel type for which advertising campaigns are grouped.

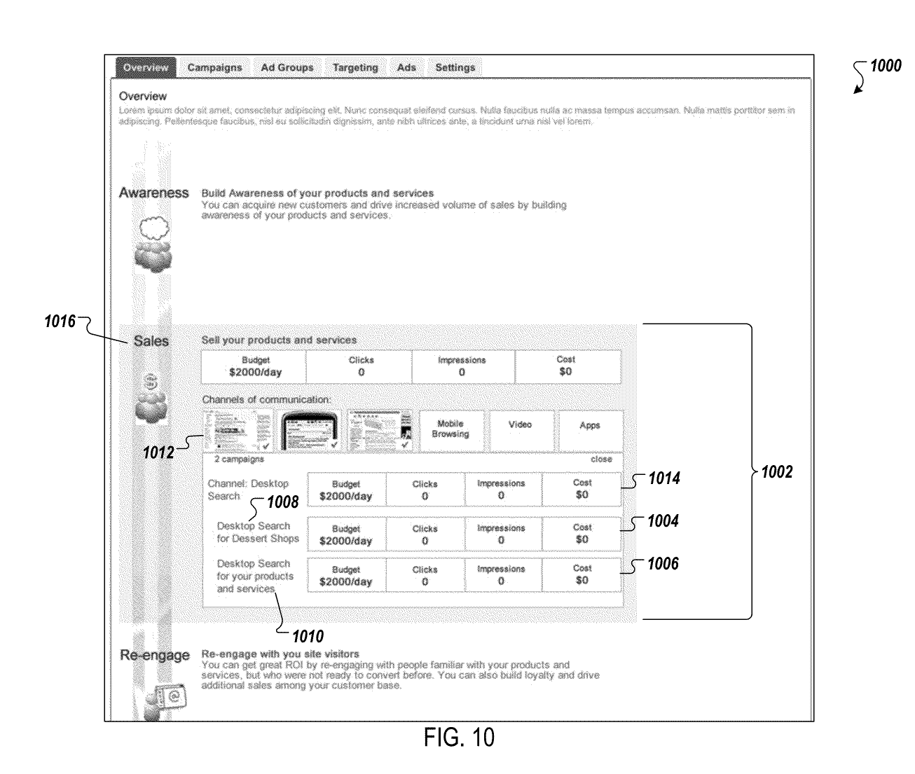

For example, FIG. 10 illustrates an example campaign summary interface 1000 for managing advertising campaigns that is displayed in response to selection of the advertising group 936 which groups advertising campaigns included in the campaign project by a media channel type of desktop search. The campaign summary interface 1000 includes, in a listing 1002 (which corresponds to the listing 934) campaign parameter values 1004 and 1006 for advertising campaigns 1008 and 1010, respectively, where the advertising campaigns 1008 and 1010 are of the media channel type associated with the selected advertising campaign group 936 (e.g., an illustrated by a corresponding advertising campaign group 1012).

Each of the campaign parameter values 1004 and 1006 include budget, clicks, impressions, and cost information. A media channel type summary area 1014 includes summary budget, clicks, impressions, and cost information that summaries information for advertising campaigns that are associated with the media channel type (e.g., desktop search) corresponding to the selected advertising group 1012 and with the advertising campaign goal associated with the corresponding goal category (e.g., a goal of sales corresponding to a goal category 1016, which corresponds to the goal category 930). Budget information displayed in the media channel type summary area 1014 can include budget values that are either shared across advertising campaigns or that are specific to one or more particular advertising campaigns.

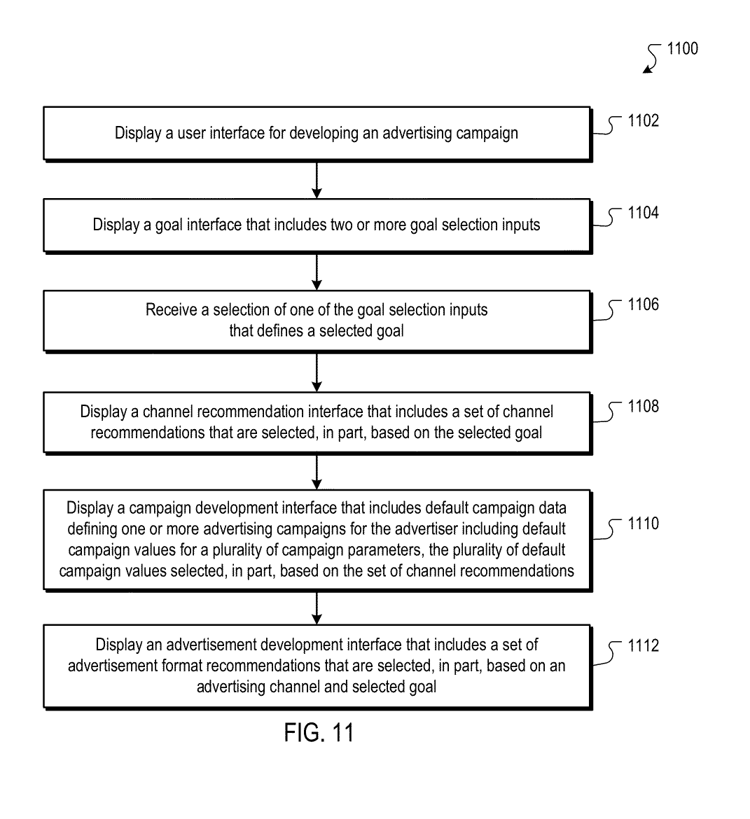

FIG. 11 is a flow diagram of an example process 1100 for developing an advertising campaign. The process 1100 can be implemented by the goal manager 118. The goal manager 118 displays, in a display device of a data processing apparatus, a user interface for developing an advertising campaign (1102). For example, as shown in FIG. 3, the goal manager 118 displays the workflow user interface 301.

The goal manager 118 displays, in the display device, a goal interface that includes two or more goal selection inputs (1104). For example, as shown in FIG. 3, the goal manager 118 displays the goal interface 303 which includes the goal selection inputs 304, 305, and 306. Each of the goal selection inputs corresponds to a respective advertising campaign goal for an advertising campaign of an advertising entity and is selectable by a user of the data processing apparatus. For example, with respect to FIG. 3, the goal selection inputs 304, 305, and 306 correspond to goals of brand recognition, sales, and re-engaging with customers, respectively.

The goal manager 118 receives a selection of one of the goal selection inputs that defines a selected goal (1106). For example, with respect to FIG. 3, the goal manager 118 receives a selection of the goal selection input 305 corresponding to a goal of sales.

The goal manager 118 displays, in the display device, a channel recommendation interface that includes a set of channel recommendations that are selected, in part, based on the selected goal (1108). For example, as shown in FIG. 4, the goal manager 118 displays the channel recommendation interface 400. The set of channel recommendations includes one or more recommendations for advertising channels, where each advertising channel is a particular media channel type for use in providing advertisements for the advertising campaign. Furthermore, each media channel type that is recommended is different from the other media channel types that are recommended in the set. For example, with respect to FIG. 4, the recommended advertising channel 402 is a desktop search media channel type, the recommended advertising channel 404 is a mobile search media channel type, and the recommended advertising channel 406 is a desktop browsing media channel type.

The goal manager 118 displays, in the display device, a campaign development interface that includes default campaign data defining one or more advertising campaigns for the advertiser, where each advertising campaign includes default campaign values for a plurality of campaign parameters, and where the plurality of default campaign values are selected, in part, based on the set of channel recommendations (1110). The default campaign values define a default advertising campaign strategy. For example, as shown in FIG. 6, the campaign development interface 600 includes default campaign data defining the advertisement campaigns 601 and 604. The campaign development interface 600 includes, among other default campaign values, default campaign values 620-648 for the campaign parameters 610-618. The default campaign values 620-648 are selected, in part, based on the recommended advertising channels 602 and 605.

The goal manager 118 displays, in the display device, an advertisement development interface that includes a set of advertisement format recommendations that are selected, in part, based on an advertising channel and selected goal (1112). The set of advertising format recommendations includes one or more recommended advertising formats for an advertisement to be provided over the advertising channel. For example, as shown in FIG. 7, the advertisement development interface 700 includes the recommended advertising formats 702-712 that are selected, in part, based on the advertising channel 716 and on the goals selected using the goal interface 300. The recommended advertising formats 702-712 can be used for advertisements that are provided over the advertising channel 716.

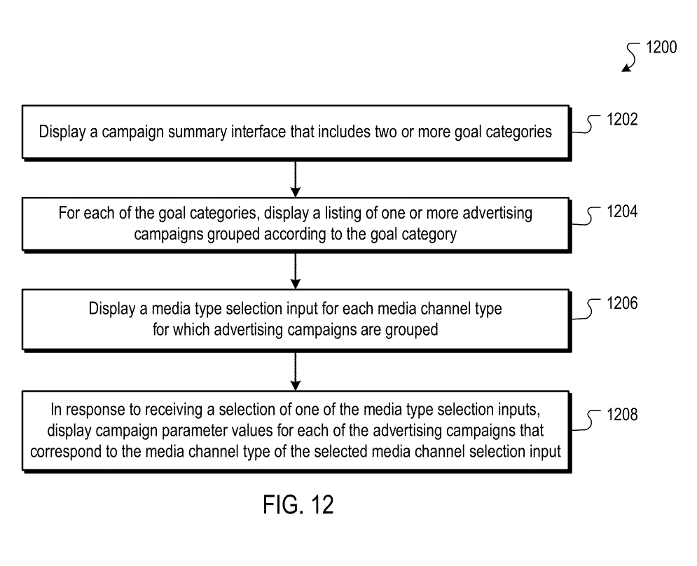

FIG. 12 is a flow diagram of an example process for displaying advertising campaign information. The process 1200 can be implemented by the goal manager 118. The goal manager 118 displays, in a display device of a data processing apparatus, a campaign summary interface that includes two or more goal categories (1202). For example, the goal manager 118 displays the goal summary interface 900 which includes three goal categories 928, 930, and 932. Each of the two or more goal categories respectively corresponds to one of the goal selection inputs and its respective advertising campaign goal. For example, the goal categories 928, 930, and 932 correspond to the goal selection inputs 304, 305, and 306, respectively, and to goals of awareness, sales, and re-engagement, respectively.

For each of the goal categories, the goal manager 118 displays, in the campaign summary interface, a listing of one or more advertising campaigns grouped according to the goal category (1204). Each of the advertising campaigns in the listing is a campaign that is defined to achieve the respective advertising campaign goal that corresponds to the goal category. For example, the listing 934 displayed in the campaign summary interface 900 includes advertising campaigns that are associated with the goal category 930 of sales.

The goal manager 118 displays, in the campaign summary interface, a media type selection input for each media channel type for which advertising campaigns are grouped (1206). For example, the campaign summary interface 900 includes the selectable advertising campaign groups 936, 938, and 940, which are associated with media channel types of desktop search, mobile search, and desktop browsing, respectively.

In response to receiving a selection of one of the media type selection inputs, the goal manager 118 displays, in the campaign summary interface, campaign parameter values for each of the advertising campaigns that correspond to the media channel type of the selected media channel selection input (1208). For example, the campaign summary interface 1000 includes campaign parameter values 1004 and 1006 which correspond to the advertising campaigns 1008 and 1010, respectively, which each correspond to the media channel type of desktop search corresponding to the selected advertising group 1012.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

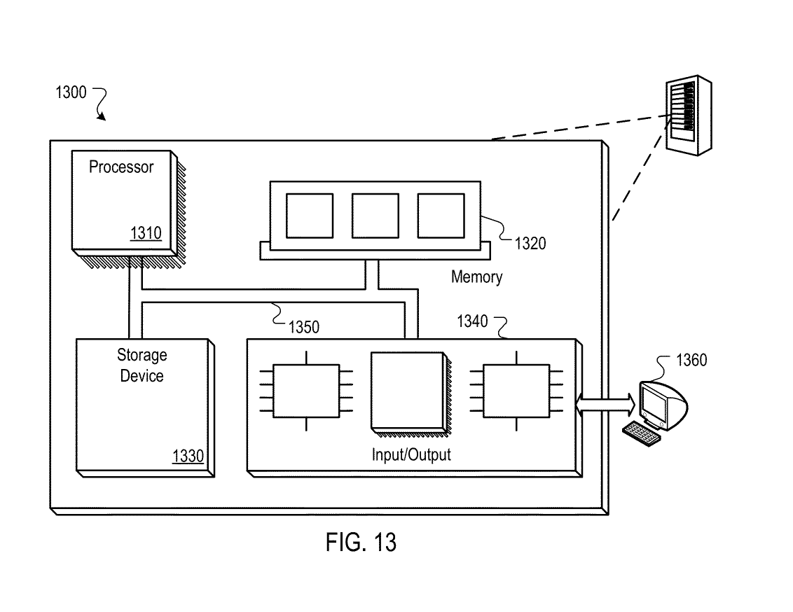

An example of computing system in which the above-described techniques can be implemented is shown in FIG. 13, which shows a block diagram of a data processing apparatus system. The system 1300 can be utilized to implement the systems and methods described herein. The architecture of the system 1300 can, for example, be used to implement a computer client, a computer server, or some other computer device.

The system 1300 includes a processor 1310, a memory 1320, a storage device 1330, and an input/output device 1340. Each of the components 1310, 1320, 1330, and 1340 can, for example, be interconnected using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330.

The memory 1320 stores information within the system 1300. In one implementation, the memory 1320 is a computer-readable medium. In one implementation, the memory 1320 is a volatile memory unit. In another implementation, the memory 1320 is a non-volatile memory unit.

The storage device 1330 is capable of providing mass storage for the system 1300. In one implementation, the storage device 1330 is a computer-readable medium. In various different implementations, the storage device 1330 can, for example, include a hard disk device, an optical disk device, or some other large capacity storage device.

The input/output device 1340 provides input/output operations for the system 1300. In one implementation, the input/output device 1340 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 1360.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1.-10. (canceled)

11. A method performed by a data processing apparatus, the method comprising:
receiving, from a client device, a selection of one of a plurality of goal selection input options, each of the goal selection input options corresponding to a respective advertising campaign goal for an advertising campaign of an advertising entity and being selectable by a user of the client device, the selection defining a selected goal from among three or more available goals including brand recognition, sales and remarketing;
receiving, from the client device, business information that includes less than all information required to distribute content from the advertising campaign including receiving a type of business associated with the advertising campaign and without receiving any specific targeting or bid information for the advertising campaign;
determining, based in part on the selected goal and by a processor of the data processing apparatus, a set of channel recommendations comprising at least one recommendation for advertising channels, each advertising channel comprising a particular media channel type for use in providing advertisements for the advertising campaign, and each media channel type being different from at least one other media channel type of the recommended advertising channels in the set wherein determining includes identifying a plurality of candidate channels, determining using historical data impressions of content associated with the business type by others in each candidate channel, and selecting a recommendation based on the determining;
determining, by the processor, one or more default campaign values for the advertising campaign, wherein the default campaign values are not included in the received business information, but are required to distribute content according to the advertising campaign and include bids, keywords, and ad format, and wherein the default campaign values are determined based on the selected goal, the set of channel recommendations, and the received business information;
providing, in response to the selected goal, data for displaying the set of channel recommendations and the default campaign values at the client device;
receiving a user selection of one or more of the channel recommendations and default values; and
creating the advertising campaign based on the user selection.

12. (canceled)

13. The method of claim 11, comprising:
determining a set of advertisement format recommendations that are selected, in part, based on an advertising channel and selected goal, the set of advertising format recommendations including at least one recommended advertising format for an advertisement to be provided over the advertising channel; and
providing data for displaying the set of advertisement format recommendations at the client device.

14. The method of claim 11, comprising:
generating a listing of at least two goal categories, each of which respectively correspond to one of the goal selection input options and its respective advertising campaign goal;
for each of the goal selection categories, generating a listing of at least one advertising campaign grouped according to the goal category, each of the at least one advertising campaign defined to achieve the respective advertising campaign goal that corresponds to the goal category; and
providing the listing for display at the client device.

15. The method of claim 14, wherein:
each listing groups the at least one advertising campaign according to a media channel type to which the advertising campaign corresponds;
at least two advertising campaigns are listed for at least one listing; and
wherein each of the two advertising campaigns corresponds to different media channel types.

16. The method of claim 15, comprising:
in response to receiving a selection indication of a selected media channel type, providing campaign parameter values for each of the advertising campaigns that correspond to the media channel type for display at the client device.

17. (canceled)

18. The method of claim 11, wherein the media channel types include at least one of desktop search, mobile search, desktop browsing, and video.

19. The method of claim 13, wherein the advertising formats include at least one of video advertisements, text advertisements, and image advertisements.

20.-26. (canceled)

27. A system, comprising:
a data processing apparatus; and
a non-transitory computer storage medium storing instructions that cause the data processing apparatus to perform operations comprising:
receiving, from a client device, a selection of one of a plurality of goal selection input options, each of the goal selection input options corresponding to a respective advertising campaign goal for an advertising campaign of an advertising entity and being selectable by a user of the client device, the selection defining a selected goal from among three or more available goals including brand recognition, sales and remarketing;
receiving, from the client device, business information that includes less than all information required to distribute content from the advertising campaign including receiving a type of business associated with the advertising campaign and without receiving any specific targeting or bid information for the advertising campaign;
determining, based in part on the selected goal, a set of channel recommendations comprising at least one recommendation for advertising channels, each advertising channel comprising a particular media channel type for use in providing advertisements for the advertising campaign, and each media channel type being different from at least one other media channel type of the recommended advertising channels in the set wherein determining includes identifying a plurality of candidate channels, determining using historical data impressions of content associated with the business type by others in each candidate channel, and selecting a recommendation based on the determining;
determining, by the processor, one or more default campaign values for the advertising campaign, wherein the default campaign values are not included in the received business information, but are required to distribute content according to the advertising campaign and include bids, keywords, and ad format, and wherein the default campaign values are determined based on the selected goal, the set of channel recommendations, and the received business information;
providing, in response to the selected goal, data for displaying the set of channel recommendations and the default campaign values at the client device;
receiving a user selection of one or more of the channel recommendations and default values; and
creating the advertising campaign based on the user selection.

28. (canceled)

29. The system of claim 27, wherein the instructions cause the data processing apparatus to perform operations comprising:
determining a set of advertisement format recommendations that are selected, in part, based on an advertising channel and selected goal, the set of advertising format recommendations including at least one recommended advertising format for an advertisement to be provided over the advertising channel; and
providing data for displaying the set of advertisement format recommendations at the client device.

30. The system of claim 27, wherein the instructions cause the data processing apparatus to perform operations comprising:
generating a listing of at least two goal categories, each of which respectively correspond to one of the goal selection input options and its respective advertising campaign goal;
for each of the goal selection categories, generating a listing of at least one advertising campaign grouped according to the goal category, each of the at least one advertising campaign defined to achieve the respective advertising campaign goal that corresponds to the goal category; and
providing the listing for display at the client device.

31. The system of claim 30, wherein:
each listing groups the at least one advertising campaign according to a media channel type to which the advertising campaign corresponds;
at least two advertising campaigns are listed for at least one listing; and
wherein each of the two advertising campaigns corresponds to different media channel types.

32. The system of claim 31, wherein the instructions cause the data processing apparatus to perform operations comprising:
in response to receiving a selection indication of a selected media channel type, providing campaign parameter values for each of the advertising campaigns that correspond to the media channel type for display at the client device.

33. (canceled)

34. A non-transitory computer storage medium storing instructions executable by a data processing apparatus and that upon such execution cause the data processing apparatus to perform operations comprising:
receiving, from a client device, a selection of one of a plurality of goal selection input options, each of the goal selection input options corresponding to a respective advertising campaign goal for an advertising campaign of an advertising entity and being selectable by a user of the client device, the selection defining a selected goal from among three or more available goals including brand recognition, sales and remarketing;
receiving, from the client device, business information that includes less than all information required to distribute content from the advertising campaign including receiving a type of business associated with the advertising campaign and without receiving any specific targeting or bid information for the advertising campaign;
determining, based in part on the selected goal, a set of channel recommendations comprising at least one recommendation for advertising channels, each advertising channel comprising a particular media channel type for use in providing advertisements for the advertising campaign, and each media channel type being different from at least one other media channel type of the recommended advertising channels in the set wherein determining includes identifying a plurality of candidate channels, determining using historical data impressions of content associated with the business type by others in each candidate channel, and selecting a recommendation based on the determining;
determining, by the processor, one or more default campaign values for the advertising campaign, wherein the default campaign values are not included in the received business information, but are required to distribute content according to the advertising campaign and include bids, keywords, and ad format, and wherein the default campaign values are determined based on the selected goal, the set of channel recommendations, and the received business information;
providing, in response to the selected goal, data for displaying the set of channel recommendations and the default campaign values at the client device;
receiving a user selection of one or more of the channel recommendations and default values; and
creating the advertising campaign based on the user selection.
